(19) United States
(12) Patent Application Publication
(10) Pub. No.: US 2008/0247750 A1
(43) Pub. Date: Oct. 9, 2008

(54) Skin Cover for Cameras

(76) Inventors: David Law, Seattle, WA (US); Ryan Morgan, Sammamish, WA (US); Graeme Esarey, Seattle, WA (US)

Correspondence Address: MAXVALUEIP CONSULTING, 11204 ALBERMYRTLE ROAD, POTOMAC, MD, 20854, US

(21) Appl. No.: 11/695,625

(22) Filed: Apr. 3, 2007

(51) Int. Cl. G03B 17/02

(52) U.S. Cl. 396/535; 206/316.2

(57) ABSTRACT

As an example, we are introducing an elastomeric molded skin, that covers the camera and provides rigorous protection against drop, dirt, and general wear-and-tear on the camera. The skin covers most, many, or all possible surfaces and replicates the existing camera buttons with elastomeric/rubber buttons, which the user can press on, to activate all the existing functions of the camera, without exposing the buttons to any dirt or moisture. The skin has both open and “open-able” areas, to allow the user access to functional areas on the camera (in this example), e.g. to replace the battery or memory card. This is particularly useful for all SLR cameras, and compact cameras with one or more LCDs.

### BACKGROUND

The cameras, especially expensive cameras, need protection against impact, heat, sun, dirt, moisture, and water. Some of the prior art are listed here:
U.S. Pat. No. 7,180,735, by Thomas, et al., teaches a protective enclosure and watertight adapter for an interactive flat-panel controlled device, including the hinge.
U.S. Pat. No. 5,173,585, by Dokken, teaches a camera heating jacket, with the heating element.

### SUMMARY

As an embodiment, we are introducing an elastomeric molded skin, which covers the camera and provides rigorous protection against drop, dirt, and general wear-and-tear on the camera. The skin covers many, most, or all surfaces and replicates the existing camera buttons with elastomeric/rubber buttons, which the user can press on, to activate all the existing functions of the camera, without exposing the buttons to any dirt or moisture. The skin has both open and “open-able” areas, to allow the user access to functional areas on the camera (in this example), e.g. to replace the battery or memory card.

### BRIEF DESCRIPTION OF THE DRAWINGS

FIG. 1 shows the skin at different angles, styles, and configurations.

FIG. 2 shows the skin at different angles, styles, and configurations.

FIG. 3 shows the skin at different angles, styles, and configurations. In particular, note the location of the hot-shoe (where the flash unit is connected to). The skin piece is pulled back (like a hinge), to let the flash unit/assembly get installed.

FIG. 4 shows the skin at different angles, styles, and configurations. Note that the pop-up flash can function, even with the skin in position.

FIG. 5 shows the skin at different angles, styles, and configurations. Note the position of the buttons and the display.

FIG. 6 shows how the battery pack is connected to the rest of the camera, relative to the skin's position.

FIG. 7 shows the lens cover/protection, with a special string, to hold the cover connected to the lens protector (the lens cap keeper).

### DETAILED DESCRIPTION OF THE PREFERRED EMBODIMENTS

Many cameras have a hot-shoe, into which one can slide and lock an external flash, that is designed to work with the camera. The design of the elastomeric skin has an additional feature which mimics the physical geometry of a hot shoe accessory. This allows this feature on the skin to be slid or snapped into the hot-shoe feature on the camera, and fastened in place. This gives the skin another anchor point and protects the top of the camera, where the hot-shoe is normally located. This hot-shoe feature on the skin can also be slid out and peeled back, to allow the flash to be used, while the camera is still protected by the skin. When the flash is in position, the skin hot-shoe feature flexes freely to one side (in this example).

Alternatively, the hot shoe cover could also attach from the side or front. Then the hot shoe protection could flex away to the side or front. This might have an advantage of not covering flash controls on the back of the flash.

Many digital cameras have LCDs which allow the user to instantly view pictures that they have just taken. Unfortunately, this is often one of the most fragile and damage-prone pieces of the camera. To protect the camera's LCD, the illustration shows a clear hard plastic LCD cover which covers the fragile LCD. The skin is made to hold this clear lens on the camera and prevent it from falling-off. The LCD cover can also be coated in various finishes to provide different functional benefits. These include antiglare coating, privacy screen, and magnification, for easier viewing of pictures taken (in this example). Another coating could be on the perimeter of the elastomeric material, so that the LCD cover is separated from the LCD by a small distance, to avoid scratching and also stopping it from sliding around.

There are often buttons and other controls in close proximity to the LCD. It is difficult to hold an LCD cover to the camera if it is very close to or the same size as the lens that is protecting (the skin which holds the cover in, cannot cover the LCD). To get around this difficulty, and ensure that the lens cover is securely held, we suggest that, by over-sizing the clear lens cover, the skin can have significant overlap, which holds the lens on securely. By making the LCD cover larger, this allows the LCD cover to mechanically anchor on large features, away from the LCD itself. The LCD cover has holes in position over the existing buttons on the camera. The elastomeric skin protrudes through the LCD cover and allows the user to press on the skin and activate the buttons through the cover (in this example). The holes also help to locate the LCD cover and the skin.

### Battery Packs, as an Embodiment

One of the main accessories that users add to their cameras is a battery pack. These are large packs of batteries that mount on the bottom of the camera, using the tripod mounting hole, to secure the battery pack to the camera. The battery pack sticks up through the battery door and contacts the battery contacts inside the camera.

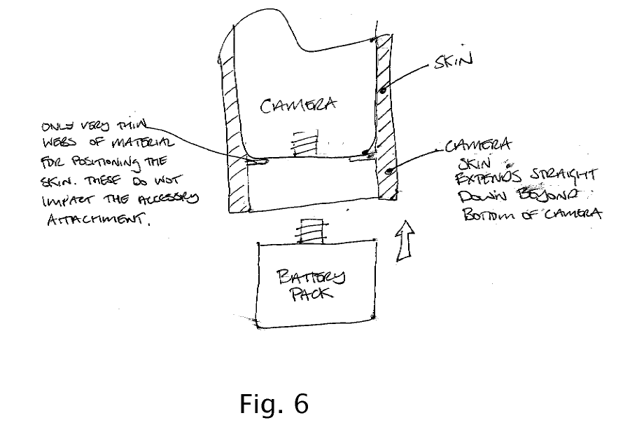

A specific feature that we have created to accommodate this popular accessory is the bottom of the camera armor skin. The thick portion of the main skin extends directly down, past the end of the camera body. A portion of the skin having a very thin wall thickness extends under the camera. This helps to hold the skin in position and still allows the battery pack to be attached. (See FIG. 6.)

This allows any accessories to be added, without causing the skin to be pushed out the way, which has a couple of advantages: First, the nominal wall thickness material that projects down below the camera body provides a large impact zone, in case of dropping. The material can buckle slightly to absorb a lot of the impact of a drop. Second, by not wrapping around the bottom, any accessories that sit on the bottom of the camera and attach to the tripod mount (which is a universal way of attaching accessories to cameras) can fit snugly to the bottom of the camera, by simply sandwiching the very thin sections between the accessory and the camera bottom.

This (optional) structure is very convenient and stable for the accessories (to be connected to camera). However, in general, it can be on any side of the camera. (i.e. the accessory can be connected to the left side of the camera, for example, if there is an input connection for that purpose located there.)

### “Lens Armor”/Lens Protector, as an Embodiment

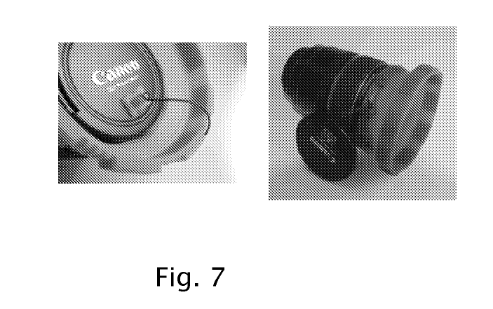

FIG. 7 shows a single piece lens protector. This is designed for two functions (once mounted onto the lens): It can both provide shading/hood for the lens, while taking a picture, and also protect the lens against bashing and damage, while in use. Current lens hoods have a threaded mount which screws onto the screw thread on the end of the lens, where filters are attached to the lens.

This lens protector is made of an elastomeric material, which allows the lens protector to be stretched over a large range of lens sizes, and therefore, one size of lens protector can accommodate multiple lenses. It also allows the lens protector to be situated at various locations on the lens, at the user's discretion. (It allows it to be flipped rolled (or generally pushed back), when not needed.) The lens protector can mount on the very end, or further up the barrel of the lens, right up to the camera body.

The lens protector also absorbs shock and impact, when the camera is dropped, or if something swings and hits the lens. This reduces the force of any impact, and therefore, increases the likelihood of the lens or the lens-to-camera-mount surviving a drop or impact. (We also call this product “Camera Armor.”) In one embodiment, it is made of a rubber skin for protecting cameras. It replaces a camera case. Two pieces in this product are: Body Armor and Lens Armor (in this example). Body Armor is the main skin that protects the camera body. Lens Armor is the elastomeric cover that goes on the end of the lens, to protect it from impact, and it can also act as a lens hood. They can stretch over, and they can also fold back.

In one embodiment, one can add a belt clip to the camera skin, so that it could be worn on the belt. Also, the skin itself (without any additional parts) can be wrapped over a belt, so that it can be worn by a user on his belt. Also, the skin can be attached to the belt, pants, skirt, shirt, or purse, with a string, tether, band, belt, or chain, through the skin, on the skin, in-between the skin (e.g. a pocket), or inside the skin.

In one embodiment, one can add different designs, text, and patterns inside or outside of the skin, for decoration, advertisement, instructions, or convenience of the user.

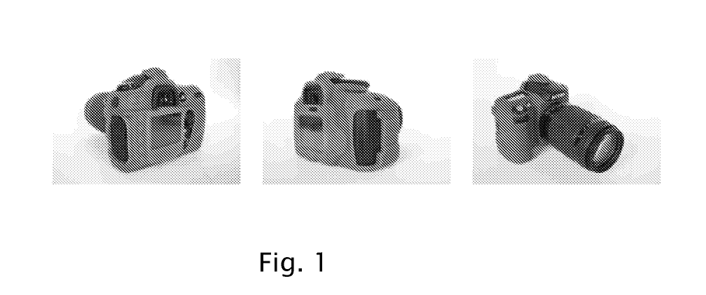

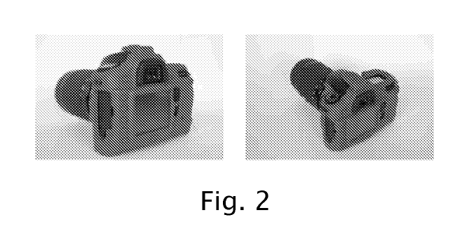

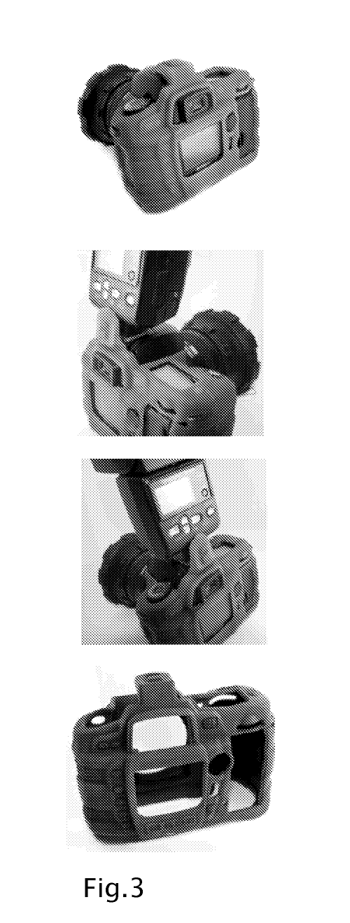

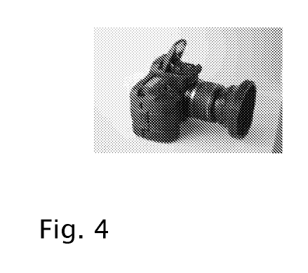

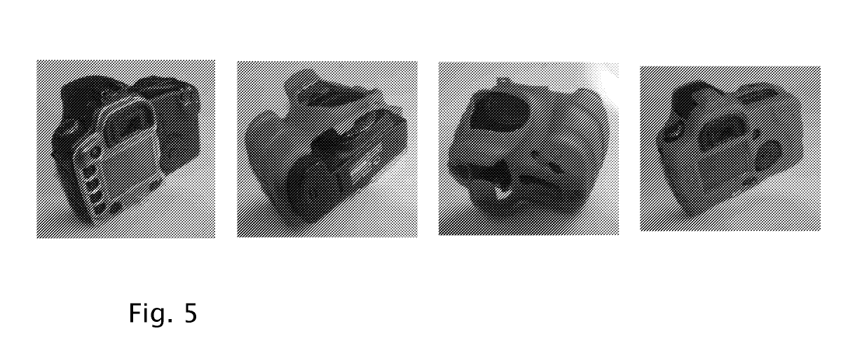

FIGS. 1-7 show the skin at different angles, styles, and configurations, including some components.

In one embodiment of this invention, the skin is mainly meant for SLR-type (single-lens reflex) cameras, custom-made or semi-custom-made for each camera model or type/manufacturer, to protect against scratch, dust, shock, vibration, impact, water, or moisture. For example, for semi-custom-made, the common dimensions and features of similar cameras are aggregated or considered, so that one skin fits a series or class of cameras, making it cheaper to produce. However, in other embodiments, it can be used for any camera, any size, and with any type of lens assembly. This includes the cell phone cameras and cameras installed, assembled, embedded, or hidden in any other objects or items. For compact cameras, this includes an LCD cover.

In one embodiment, the skin for SLR cameras is secured this way: remove the lens assembly, put the skin on, and re-attach the lens assembly. This way, the lens assembly prevents the skin from falling or slipping off the camera (keep the skin in position). In one embodiment, this consists of 2 pieces.

In one embodiment, the LCD protector (skin) has 2 pieces. It can have a protective membrane over LCD (or used for clear lens). The skin is made of rubber, stretchable, soft, and elastic, stretching over a form and conforming to a shape.

In one embodiment, the LCD protector (skin) has 3 pieces: (1) LCD shield, protected by hard clear plastic, (2) main skin for the body of camera, holding LCD shield in place, and (3) Lens Shield Armor, circular shape, positioned over the lens.

In one embodiment, the LCD protector (skin) has only 1 piece.

In one embodiment, the hard plastic shield is attached to the rest of the assembly with a clip. (There has to be a feature on the camera to hook on (get attached).) In another embodiment, the hard plastic shield is a part of the skin, as one piece, molded or pre-manufactured in a factory.

In one embodiment, the LCD cover is held by a part of the camera. In one embodiment, the skin goes on top of the hard plastic shield, to hold it in place. In one embodiment, for compact cameras, a clip is used to hold the LCD cover (or using screw, glue, or other means of attachment). Normally, the LCD shield is on the back side, but in principal, it can be on any side of the camera, and it can be for any purpose, e.g. displaying the objects in the view of camera, displaying the information about the camera, or displaying any general information, such as text messaging or a calculator function. The camera may have multiple LCDs, used for same function or multiple purposes, located at (or connected to) different parts of the camera.

The LCD cover or lens cover can be made of transparent, translucent, reflective, clear, or semi-clear material. In one embodiment, the cover is a film which sticks to the surfaces by static force (or low adhesive surface or “vinyl magnet”). In one embodiment, to access the buttons, either they are directly exposed to the user, or they are protected by a specific part of the skin (usually a thin, flexible, clear, and visible piece of skin). In one embodiment, the skin comprises multiple flaps, which can be pulled back, to let the user access different parts of the camera.

In one embodiment, the lens assembly is also protected, with the same piece of skin, or with an extra piece of skin or cover, which may or may not get attached to the rest of the skin or camera. In one embodiment, the lens protector covers just the lens. In one embodiment, the lens protector covers the shaft of the lens assembly, plus the front of the lens. Normally, this requires flexible material, to be able to fit multiple types of lenses, with different shapes and sizes.

In one embodiment, the skin is made of one or more of the following materials or structures: plastic, elastic material, nylon, bubble-protection material, layered material, soft material, synthetic material, shock absorbent material, hard material, solid material, liquid-containing material, gas-containing material, pressurized-gas-containing material, balloon-type material, inflatable material, gel-type material, natural material, leather, water-proof material, oil-protected surface, paper, cardboard, stretchable material, elastic band network, net-shape material, magnetic material, metallic material, metallic chain, array of metallic rings, multi-dimensional structure, folded structure, hinges, hinged plates, hinged micro-plates, connected tiles, Lego-shaped material, brick-shaped material, ceramic tiles, stone tiles, artificial material tiles, glass tiles, transparent material, translucent material, reflective material, fluorescent material, metal-plated material, painted material, rug, woven material, bamboo, carpet material, wooden material, sticks, insulation material, water-cooling jacket, air-cooling jacket, heating-element jacket, insulation jacket, or any similar, compound, chemical, or composite material.

In one embodiment, the skin includes (in, attached to, or on it) one or more of the following items: a picture frame, clock, notebook, calculator, solar cell array, battery, pen holder, pen, pencil, magnetic plate, magnetic decoration, light, LED, LCD, display, small TV, small radio, thermometer, pressure gauge, biometric sensor, thumb/fingerprint recognition module, combination lock, lock, Velcro, hook-and-loop, password entry input, small keyboard, input device, pointing device, speaker, microphone, small telephone set, keychain ring, hook (for hanging the unit), small video game, music player, downloading unit (from Internet or satellite), wireless unit, communication unit, antenna, small computer, small web browser, recorder, or any other electronic or mechanical device, apparatus, system, toy, decoration, or equipment.

### Inflatable Skin Cover, as an Embodiment, to Fit (Almost) any Size Camera

In one embodiment, the skin cover comprises multiple layers. In one embodiment, the skin cover is inflatable. In one embodiment, the skin cover is inflated using one or more of the following, or combination or mixture of the following: gas, liquid, solid, dust, gel-type, liquidated-solid, pressurized fluid, water-absorbent sponge, sponge-type material, or any expandable solid, liquid, fluid, chemical, gas, or material, caused by chemical reaction, heat, temperature variation, catalyst, chain reaction, exceeding critical mass, seed material, mixing, or pressure.

In one embodiment, the size or shape of said skin cover is adjusted based on the size, model, or type of the camera. In one embodiment, the inflation is adjusted based on the size, model, or type of the camera. In one embodiment, the size or shape of said skin cover is adjusted by one or more of the following, or a combination of the following: a user, a computer, feedback from one or more sensors, feedback module, pressure gauges at different points, data about the model number or type of said camera, data about the dimensions or weight of said camera, fuzzy logic system, a training module, or a neural network module. In one embodiment, the skin cover has multiple parts or chambers, each of which can be optimized, or inflated separately, or in concert, with respect to each other.

In one embodiment, a database holds all the information about specific cameras, to inflate the components or parts accordingly, to fit the camera. The more individual chamber or parts we have (smaller chambers), the easier one can make it fit to the shape of a specific camera. The chambers can be connected together, or can be individually inflated, independent of each other.

This embodiment is useful for semi-custom-made or generic skin cover, to act or behave as a custom-made skin cover (fit perfectly with the camera).

Any other variation of the above teaching is also meant to be protected by the current patent.

1. A skin cover for a camera,
wherein said skin cover comprises an elastic molded material,
wherein said skin cover covers said camera,
wherein said skin cover comprises one or more elastic or rubber buttons which mirror, associated with, or correspond to said camera's buttons, and
wherein said skin cover comprises one or more open areas, accessible areas, extensions, or flaps, to allow a user access or use one or more functional areas on said camera.

2. A skin cover for a camera,
wherein said skin cover comprises an elastic molded material,
wherein said skin cover covers said camera, and
wherein said camera is a single-lens reflex camera.

3. A skin cover for a camera,
wherein said skin cover comprises an elastic molded material,
wherein said skin cover covers said camera,
wherein said camera is a compact camera, and
wherein said skin cover comprises a display cover.

4. A skin cover for a camera as recited in claim 3, wherein said display is an LCD display.

5. A skin cover for a camera as recited in claim 1, wherein said one or more functional areas on said camera comprises or relates to one or more of the following: battery, memory card, flash assembly, pop-up flash, hot-shoe, tripod mounting hole, tripod, LCD, display, or lens assembly.

6. A skin cover for a camera as recited in claim 1, wherein said one or more functional areas on said camera are located at one or more of the following: on the bottom of said camera, on the sides of said camera, on the top of said camera, on the back of said camera, or on the front of said camera.

7. A skin cover for a camera as recited in claim 1, wherein said skin cover comprises a lens protector.

8. A skin cover for a camera as recited in claim 1, wherein said skin cover stretches over a lens protector.

9. A skin cover for a camera as recited in claim 1, wherein said skin cover is attached to a lens protector.

10. A skin cover for a camera as recited in claim 1, wherein said skin cover is attached to a belt, pants, skirt, shirt, or purse.

11. A skin cover for a camera as recited in claim 1, wherein the inside or outside of said skin cover comprises designs, text, or patterns.

12. A skin cover for a camera as recited in claim 11, wherein said designs, text, or patterns are for decoration, advertisement, instructions, or convenience of a user.

13. A skin cover for a camera as recited in claim 1, wherein said skin cover is either custom-made for a specific camera, or semi-custom-made for a class, family, or type of a camera.

14. A skin cover for a camera as recited in claim 1, wherein said skin cover comprises multiple layers.

15. A skin cover for a camera as recited in claim 1, wherein said skin cover is inflatable.

16. A skin cover for a camera as recited in claim 15, wherein said skin cover is inflated using one or more of the following, or combination or mixture of the following: gas, liquid, solid, dust, gel-type, liquidated-solid, pressurized fluid, water-absorbent sponge, sponge-type material, or any expandable solid, liquid, fluid, chemical, gas, or material, caused by chemical reaction, heat, temperature variation, catalyst, chain reaction, exceeding critical mass, seed material, mixing, or pressure.

17. A skin cover for a camera as recited in claim 16, wherein the size or shape of said skin cover is adjusted based on the size, model, or type of the camera.

18. A skin cover for a camera as recited in claim 17, wherein the size or shape of said skin cover is adjusted by one or more of the following, or a combination of the following: a user, a computer, feedback from one or more sensors, feedback module, pressure gauges at different points, data about the model number or type of said camera, data about the dimensions or weight of said camera, fuzzy logic system, a training module, or a neural network module.

19. A skin cover for a camera as recited in claim 1, wherein said skin cover is made of or comprises one or more of the following materials or structures: plastic, elastic material, nylon, bubble-protection material, layered material, soft material, synthetic material, shock absorbent material, hard material, solid material, liquid-containing material, gas-containing material, pressurized-gas-containing material, balloon-type material, inflatable material, gel-type material, natural material, leather, water-proof material, oil-protected surface, paper, cardboard, stretchable material, elastic band network, net-shape material, magnetic material, metallic material, metallic chain, array of metallic rings, multi-dimensional structure, folded structure, hinges, hinged plates, hinged micro-plates, connected tiles, Lego-shaped material, brick-shaped material, ceramic tiles, stone tiles, artificial material tiles, glass tiles, transparent material, translucent material, reflective material, fluorescent material, metal-plated material, painted material, rug, woven material, bamboo, carpet material, wooden material, sticks, insulation material, water-cooling jacket, air-cooling jacket, heating-element jacket, insulation jacket, or any similar material, compound, chemical, or composite material.

20. A skin cover for a camera as recited in claim 1, wherein said skin cover is attached to one or more of the following items: a picture frame, clock, notebook, calculator, solar cell array, battery, pen holder, pen, pencil, magnetic plate, magnetic decoration, light, LED, LCD, display, small TV, small radio, thermometer, pressure gauge, biometric sensor, thumb or fingerprint recognition module, combination lock, lock, Velcro, hook-and-loop, password entry input, small keyboard, input device, pointing device, speaker, microphone, small telephone set, keychain ring, hook, small video game, music player, downloading unit, wireless unit, communication unit, antenna, small computer, small web browser, recorder, or any electronic or mechanical device, apparatus, system, toy, decoration, or equipment.
